(19) United States
(12) Patent Application Publication
(10) Pub. No.: US 2026/0195678 A1
(43) Pub. Date: Jul. 9, 2026

(54) PROCESSING DEVICE, PROCESSING METHOD, AND PROCESSING PROGRAM

(71) Applicant: Nippon Telegraph and Telephone Corporation, Tokyo (JP)

(72) Inventors: Hidetaka KOYA, Musashino-shi, Tokyo (JP); Akira KATAOKA, Musashino-shi, Tokyo (JP)

(21) Appl. No.: 18/863,807

(22) PCT Filed: May 12, 2022
(86) PCT No.: PCT/JP2022/020103

§ 371 Date: Nov. 7, 2024

(51) Int. Cl. G06Q 10/0631

(52) U.S. Cl. CPC G06Q 10/06316

(57) ABSTRACT

A processing device includes processing circuitry configured to designate an automatic operation target displayed on a system screen, and register and manage position information and an alias of the designated automatic operation target as target information, describe control of an automatic operation by a low code and/or no code using the target information registered, describe an execution condition when the execution condition exists, and convert the execution condition into a predetermined script, monitor information of an application on a desktop, determine whether or not an execution condition set is satisfied, and output a corresponding script when it is determined that the execution condition is satisfied, and interpret the script converted, replace the alias with object information of an automatic operation target, sequentially process the script, and perform an automatic operation of the system screen.

### TECHNICAL FIELD

The present invention relates to a processing device, a processing method, and a processing program.

### BACKGROUND ART

Business efficiency has been improved by automation of a system operation using robotic process automation (RPA). In RPA, a procedure of automatic operation is described in the form of a scenario or a rule. In many cases, RPA has a mechanism of low code/no code development that makes it easy for a non-programmer to describe a procedure.

There is a method of describing a procedure of automatic operation in the form of a scenario according to a flowchart (see Non Patent Literature 1). In the method described in Non Patent Literature 1, actions such as “click” and “character string setting” are defined as blocks of a flowchart, and they are connected to describe control. In this method, information on an automatic operation target is included in a block of each action.

In addition, there is a method of describing a procedure of automatic operation in a dedicated script language or various programming languages (see Non Patent Literature 2). In the method described in Non Patent Literature 2, control is described by a syntax of each language, an application programming interface (API)/command, or the like, and target information is hard-coded as an argument of the API/command.

### CITATION LIST

### Non Patent Literature

Non Patent Literature 1: Fumihiro Yokose, Hiroyuki Tanaka, Takahiro Toyoda, Kentaro Hotta, Akira Inoue, Satoru Sugimoto, “An Overview of the UMS: Software to Automate Operators' Actions,” IEICE Technical Report, ICM2011-73, p.149-154, 2012.
Non Patent Literature 2: Software Freedom Conservancy, “The Selenium Browser Automation Project,” [online], [retrieved on Mar. 28, 2022], the Internet <URL: https://www.selenium.dev/documentation/>

### SUMMARY OF INVENTION

### Technical Problem

As described above, in existing RPA, targets that are automatic operation targets and are susceptible to environmental factors such as a system screen, and control of how to process the targets are integrally described as scenarios and rules.

Therefore, in existing RPA, there is a problem that it is necessary to correct all scenarios and rules related to the corresponding system screen in a case where there is an environment change such as when a system screen that is an automatic operation target is corrected due to system renewal or the like.

The present invention has been made in view of the above, and an object of the present invention is to provide a processing device, a processing method, and a processing program capable of reducing an influence on correction of a scenario and a rule due to an environment change.

### Solution to Problem

In order to solve the above-described problems and achieve the object, a processing device according to the present invention includes: a registration unit that designates an automatic operation target displayed on a system screen, and registers and manages position information and an alias of the designated automatic operation target as target information; a description unit that describes control of an automatic operation by a low code and/or no code using the target information registered by the registration unit, describes an execution condition when the execution condition exists, and converts the execution condition into a predetermined script; a monitoring unit that monitors information of an application on a desktop, determines whether or not an execution condition set by the description unit is satisfied, and outputs a corresponding script when it is determined that the execution condition is satisfied; and an execution unit that interprets the script converted by the description unit, replaces the alias with object information of an automatic operation target, sequentially processes the script, and performs an automatic operation of the system screen.

### Advantageous Effects of Invention

According to the present invention, it is possible to reduce the influence of the environment change on the correction of the scenario and the rule.

### BRIEF DESCRIPTION OF DRAWINGS

FIG. 1 is a diagram schematically illustrating an example of a configuration of a processing device according to an embodiment.

FIG. 2 is a flowchart illustrating a processing procedure of automatic operation processing of a system screen according to the embodiment.

FIG. 3 is a flowchart illustrating a processing procedure of target registration processing illustrated in FIG. 2.

FIG. 4 is a flowchart illustrating a processing procedure of control description processing illustrated in FIG. 2.

FIG. 5 is a view illustrating an example of a menu screen displayed on the automatic operation target device.

FIG. 6 is a view illustrating an example of a menu screen displayed on the automatic operation target device.

FIG. 7 is a view illustrating an example of a menu screen displayed on the automatic operation target device.

FIG. 8 is a view illustrating an example of a menu screen displayed on the automatic operation target device.

FIG. 9 is a view illustrating an example of a menu screen displayed on the automatic operation target device.

FIG. 10 is a view illustrating an example of a menu screen displayed on the automatic operation target device.

FIG. 11 is a view illustrating an example of a menu screen displayed on the automatic operation target device.

FIG. 12 is a view illustrating an example of a menu screen displayed on the automatic operation target device.

FIG. 13 is a view illustrating an example of a menu screen displayed on the automatic operation target device.

FIG. 14 is a view illustrating an example of a menu screen displayed on the automatic operation target device.

FIG. 15 is a view illustrating an example of a menu screen displayed on the automatic operation target device.

FIG. 16 is a view illustrating an example of a menu screen displayed on the automatic operation target device.

FIG. 17 is a view illustrating an example of a menu screen displayed on the automatic operation target device.

FIG. 18 is a view illustrating an example of a menu screen displayed on the automatic operation target device.

FIG. 19 is a view illustrating an example of a menu screen displayed on the automatic operation target device.

FIG. 20 is a view illustrating an example of a menu screen displayed on the automatic operation target device.

FIG. 21 is a view illustrating an example of a menu screen displayed on the automatic operation target device.

FIG. 22 is a flowchart illustrating a procedure of update processing of a target list when a system screen is changed.

FIG. 23 is a view illustrating an example of a menu screen displayed on the automatic operation target device.

FIG. 24 is a view illustrating an example of a menu screen displayed on the automatic operation target device.

FIG. 25 is a view illustrating an example of a menu screen displayed on the automatic operation target device.

FIG. 26 is a view illustrating an example of a menu screen displayed on the automatic operation target device.

FIG. 27 is a view illustrating an example of a menu screen displayed on the automatic operation target device.

FIG. 28 is a view illustrating an example of a menu screen displayed on the automatic operation target device.

FIG. 29 is a view illustrating an example of a menu screen displayed on the automatic operation target device.

FIG. 30 is a view illustrating an example of a menu screen displayed on the automatic operation target device.

FIG. 31 is a diagram illustrating an example of a computer on which a processing device is implemented by executing a program.

### DESCRIPTION OF EMBODIMENTS

Hereinafter, an embodiment of the present invention will be described in detail with reference to the drawings. Note that the present invention is not limited by this embodiment. Furthermore, in the description of the drawings, the same parts are denoted by the same reference numerals.

[Embodiment] In the present embodiment, a processing device and a processing method for performing an automatic operation of a system screen will be described.

In the present embodiment, information about an automatic operation is separated into control and target information and managed, Here, the target is an object that is an automatic operation target, such as a button or a text box on the system screen. The control is a process of setting a value for an automatic operation target, a process of acquiring the set value, a process of repeating these processes, and a process of branching depending on conditions.

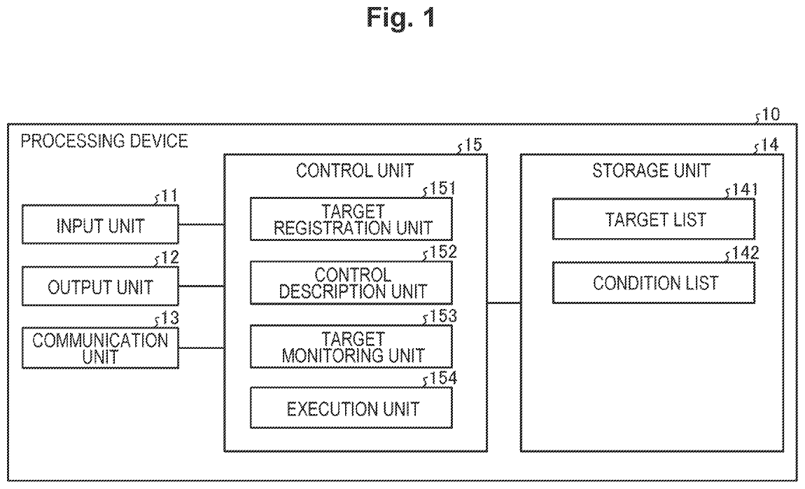

In the embodiment, information susceptible to an environment change such as system renewal is generated as target information (alias (byname), monitoring condition) for each system, and various controls on the same system are described using common target information (alias (byname), monitoring condition). As a result, in the embodiment, when an environment change such as a change of the system screen occurs, only the target information is corrected, and therefore correction is not necessary for the control described using the target information.

[Processing Device] A processing device according to an embodiment will be described. As illustrated in FIG. 1, the processing device 10 includes an input unit 11, an output unit 12, a communication unit 13, a storage unit 14, and a control unit 15.

The input unit 11 is realized using an input device such as a keyboard, a mouse, or a microphone and inputs various types of instruction information such as processing start to the control unit 15 in response to an input operation of an operator. The output unit 12 is realized by a speaker, a display device (desktop) such as a liquid crystal display, a printing device such as a printer, or the like.

The communication unit 13 is realized by a network interface card (NIC) or the like, and controls communication between an external device and the control unit 15 via an electric communication line such as a local area network (LAN) or the Internet.

The storage unit 14 is a storage device such as a hard disk drive (HDD), a solid state drive (SSD), or an optical disc. Note that the storage unit 14 may be a semiconductor memory capable of rewriting data, such as a random access memory (RAM), a flash memory, or a non volatile static random access memory (NVSRAM). In the storage unit 14, a processing program for operating the processing device 10, data used during execution of the processing program and the like are stored in advance, or temporarily stored each time processing is performed. Note that the storage unit 14 may be configured to communicate with the control unit 15 via the communication unit 13.

The storage unit 14 includes a target list 141 and a condition list 142. The target list 141 is a list of target information in which position information and an alias of an automatic operation target are registered. The condition list 122 is a list of monitoring conditions set using the alias. The conditions include an existence condition, a value condition, and/or a timing condition.

The control unit 15 controls the entire processing device 10, The control unit 15 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

Further, the control unit 15 includes an internal memory for storing programs and control data defining various processing procedures, and executes each type of processing using the internal memory. Furthermore, the control unit 15 functions as various processing units by operating various programs. For example, the control unit 15 includes a target registration unit 151 (registration unit), a control description unit 152 (description unit), a target monitoring unit 153 (monitoring unit), and an execution unit 154.

The target registration unit 151 designates an automatic operation target displayed on the system screen, and registers and manages position information and an alias of the designated automatic operation target as target information. The target registration unit 151 generates information susceptible to an environment change such as a system renewal as target information (alias, monitoring condition) for each system, and describes various controls for the same system using common target information (alias, monitoring condition).

The position information registered by the target registration unit 151 is represented hierarchically by object information or an index. The target registration unit 151 defines a unique alias for each piece of position information.

The target registration unit 151 sets a monitoring condition (hereinafter referred to as a condition) using the alias. The conditions include an existence condition, a value condition, and/or a timing condition. The target registration unit 151 defines a unique condition name for each condition.

The control description unit 152 describes the control of the automatic operation by a low code and/or no code using the target information registered by the target registration unit 151. The control description unit 152 describes an execution condition when there is an execution condition.

Then, the control description unit 152 converts the execution condition into a predetermined script that can be interpreted by the execution unit 154 (described below). The control description unit 152 describes control using either an execution method of immediate execution or execution when an execution condition set by combining condition names is satisfied.

The target monitoring unit 153 monitors information of an application displayed on the desktop, and determines whether or not the execution condition set by the control description unit 152 is satisfied. When it is determined that the execution condition is satisfied, in other words, when a situation matching the execution condition given by the control description unit 152 occurs, the target monitoring unit 153 outputs a script corresponding to the execution condition and passes the script to the execution unit 154.

The execution unit 154 is implemented by an arbitrary script engine. The execution unit 154 interprets the script converted by the control description unit 152. The execution unit 154 performs the automatic operation of the system screen by replacing the alias with the object information of the automatic operation target and sequentially processing the script.

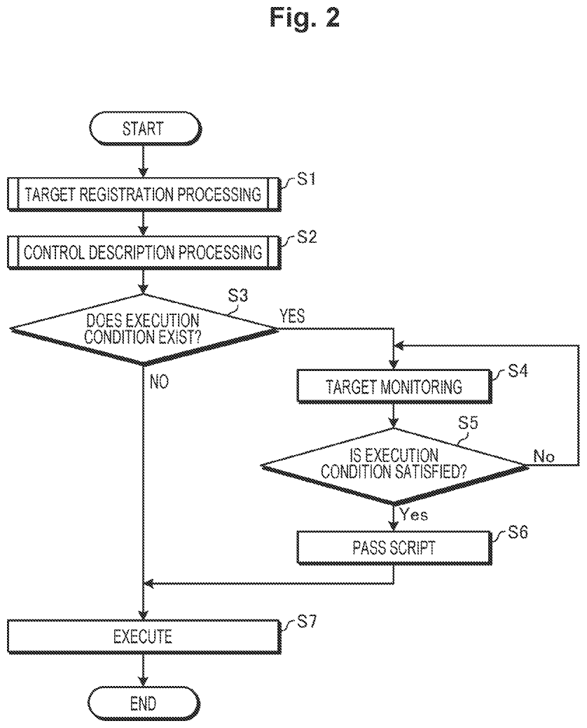

The execution unit 154 acquires the position information from the alias of the target information described in the script, searches for an automatic operation target matching the position information from among the applications displayed on the current desktop, and replaces the automatic operation target with the object information. The execution unit 154 sequentially processes the replaced script and executes the automatic operation.

[Automatic Operation Processing of System Screen] FIG. 2 is a flowchart illustrating a processing procedure of automatic operation processing of the system screen according to the embodiment.

As illustrated in FIG. 2, first, the processing device 10 designates an automatic operation target displayed on the system screen, and performs target registration processing of registering position information and an alias of the designated automatic operation target as target information (step S1).

Using the target information registered in the target registration processing, the processing device 10 performs control description processing of describing control of the automatic operation by a low code and/or no code, describing an execution condition when there is the execution condition, and converting the execution condition into a predetermined script interpretable by the execution unit 154 (step S2).

The target monitoring unit 153 determines whether or not there is an execution condition in the output in the control description processing (step S3). If there is an execution condition (step S3: Yes), the target monitoring unit 153 performs target monitoring for monitoring an application displayed on the desktop (step S4), and determines whether a situation that satisfies the execution condition given in the control description processing has occurred (step S5).

When determining that the situation satisfying the execution condition does not occur (step S5; No), the target monitoring unit 153 returns to step S4 and performs target monitoring. When determining that a situation satisfying the execution condition has occurred (step S5: Yes), the target monitoring unit 153 passes the corresponding script to the execution unit 154 (step S6).

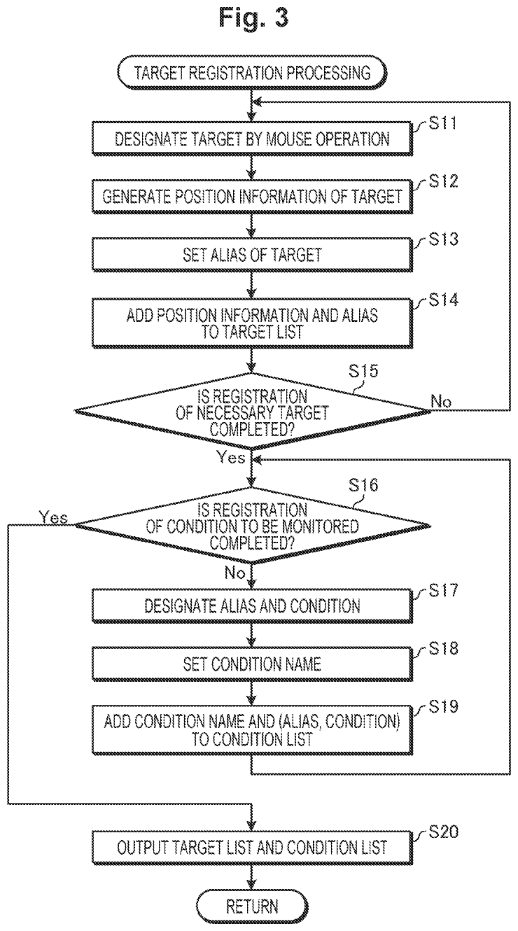

In a case where there is no execution condition (step S3: No), and after the processing of step S6, the execution unit 154 interprets the corresponding script, replaces the alias with the object information of the automatic operation target, sequentially processes the Script, and executes the automatic operation of the system screen (step S7).

[Target Registration Processing] Next, the target registration processing (step S1) will be described. FIG. 3 is a flowchart illustrating a processing procedure of the target registration processing illustrated in FIG. 2.

As illustrated in FIG. 3, when the automatic operation target is designated by mouse operation (step S11), the target registration unit 151 generates position information of the automatic operation target (step S12), and sets an alias of the automatic operation target (step S13). Then, the target registration unit 151 adds the position information and the alias generated in steps S12 and S13 to the target list as one set of target information (step S14).

The target registration unit 151 determines whether a registration of a necessary automatic operation target has been completed (step S15). When the registration of the necessary automatic operation target is not completed (step S15: No), the target registration unit 151 returns to step S11.

When registration of a necessary automatic operation target is completed (step S15: Yes), the target registration unit 151 determines whether the registration of the condition to be monitored is completed (step S16).

When the registration of the condition to be monitored is not completed (step S16: No), the target registration unit 151 designates an alias and a condition (step S17) and sets a condition name (step S18). The target registration unit 151 adds the condition name and the (alias, condition) designated and set in steps S17 and S18 to the condition list (step S19), and returns to step S16.

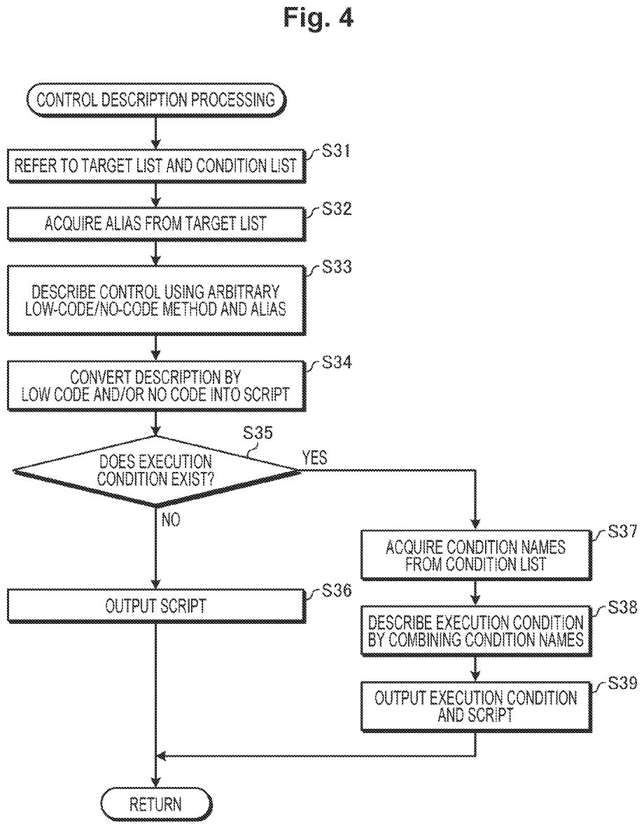

When the registration of the condition to be monitored is completed (step S16: Yes), the target registration unit 151 outputs the target list and the condition list (step S20).

[Control Description Processing] Next, the control description processing (step S2) will be described. FIG. 4 is a flowchart illustrating a processing procedure of the control description processing illustrated in FIG. 2.

As illustrated in FIG. 4, the control description unit 152 refers to the target list 141 and the condition list 142 (step S31). The control description unit 152 acquires an alias from the target list (step S32), and describes the control of the automatic operation using an arbitrary low code/no code method and the alias (step S33). The control description unit 152 converts the description by the low code and/or no code into a predetermined script that can be interpreted by the execution unit 154 (step S34).

The control description unit 152 determines whether or not there is an execution condition corresponding to this control (step S35). When there is no execution condition (step S35: No), the control description unit 152 outputs the corresponding script to the execution unit 154 (step S36).

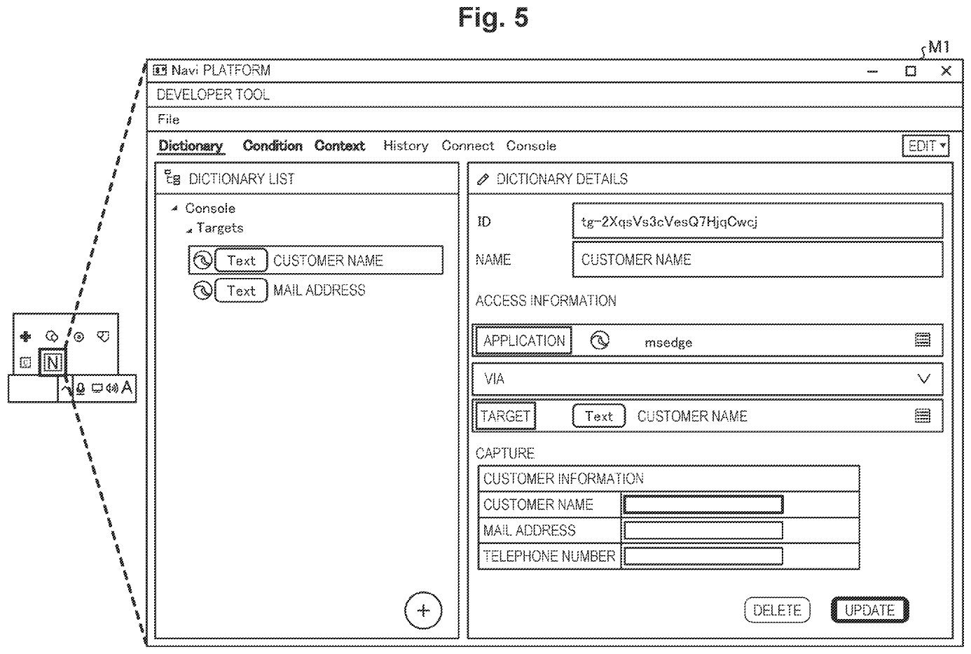

When there is an execution condition (step S35: Yes), the control description unit 152 acquires condition names from the condition list (step S37), and describes the execution condition by combining the acquired condition names (step S38). The control description unit 152 outputs the described execution condition and script to the execution unit 154 (step S39).

[Implementation Example] Next, an implementation example of automatic operation control processing in the present embodiment will be described. FIGS. 5 to 20 are diagrams illustrating an example of a menu screen displayed on the automatic operation target device. The automatic operation target device may be a terminal device to which the processing device 10 is connected, in addition to the processing device 10.

As illustrated in FIG. 5, the present embodiment is realized as software in which an execution unit 154, a target registration unit 151, and a target monitoring unit 153 are mounted as an application resident in a task tray, for example. As illustrated in FIG. 5, when a user selects software (in a frame) resident in the task tray, a menu M1 is displayed as a developer tool.

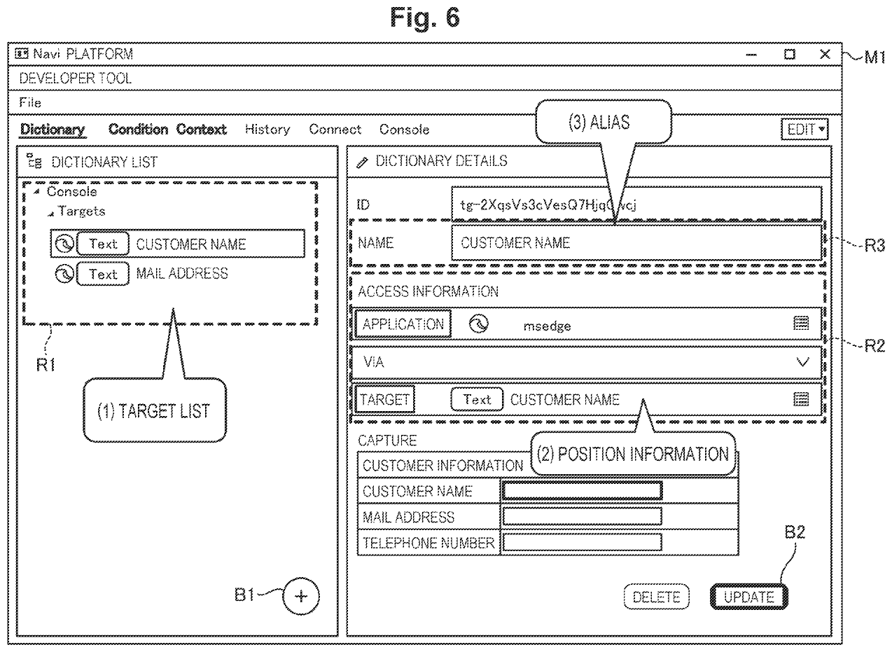

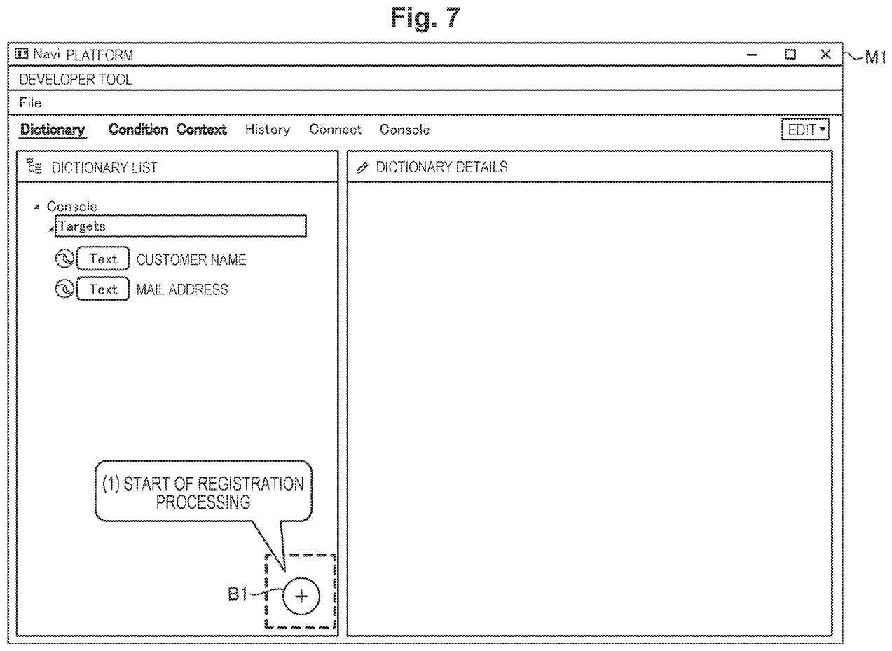

When the automatic operation target is set, the target list is displayed in a left region R1 on the Dictionary screen of the menu M1 ((1) in FIG. 6). On the Dictionary screen, the position information is displayed in a right region R2 ((2) in FIG. 6), and the alias is displayed in a right region R3 ((3) in FIG. 6). Note that a start button B1 of the registration processing and a registration update button B2 are displayed on the Dictionary screen.

[Target Registration] First, target registration processing will be described. As illustrated in FIG. 7, first, the user instructs the start of the registration processing by selecting the start button B1 of the Dictionary screen of the menu M1 ((1) in FIG. 7).

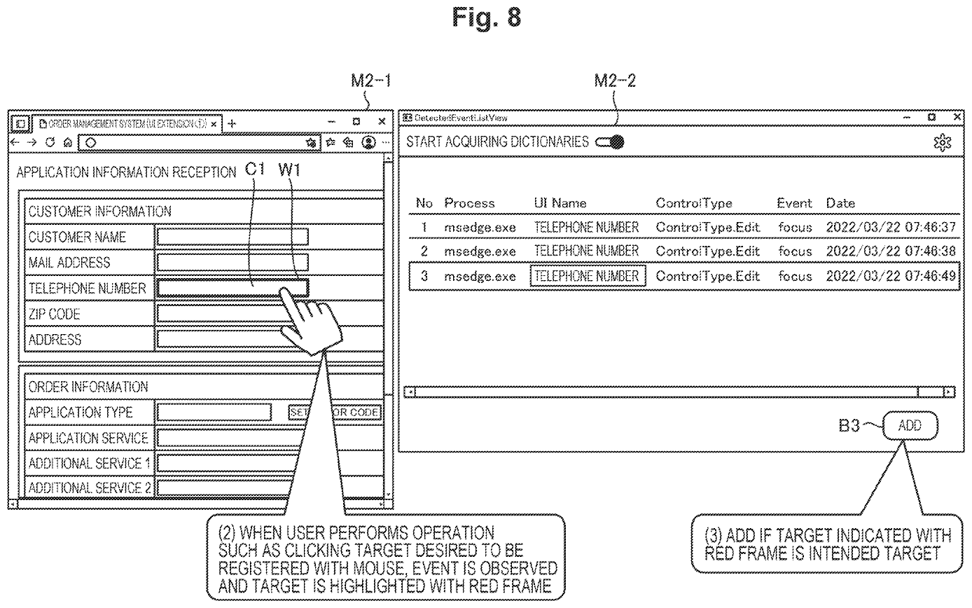

Accordingly, a dictionary acquisition start menu M2-2 is displayed. When the user performs an operation such as clicking a target C1 of the automatic operation desired to be registered with a mouse, the clicked event is observed and the target is highlighted with a red frame W1 ((2) in FIG. 8). In this example, since the target C1 is a telephone number, the observed events are listed in the dictionary acquisition start menu M2-2 (in this example, an event of focusing on a telephone number is listed). The user selects an add button B3 if the target C1 added with the red frame W1 is intended to be an automatic operation target ((3) in FIG. 8).

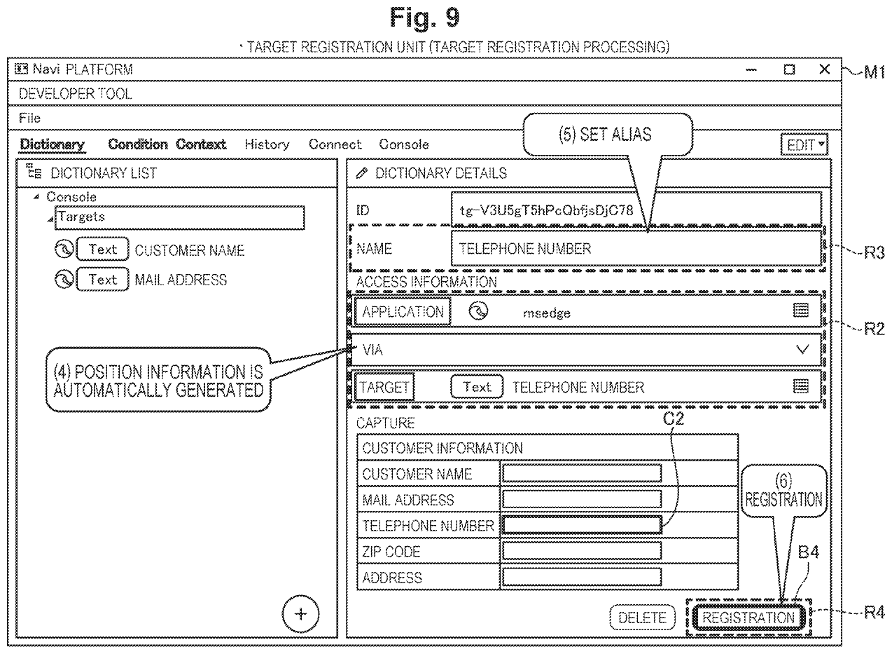

The target registration unit 151 designates the selected target C1 and generates position information of the designated target C1. As a result, the position information of the target C1 is automatically generated ((4) in FIG. 9) and displayed in the region R2 on the left side of the menu M1. Then, the target registration unit 151 sets the alias of the target C1 as “telephone number” ((5) of FIG. 9, region R3). Note that the telephone number of the target C1 selected in an application information reception menu M2-1 of FIG. 8 is displayed in a telephone number field C2 of “customer information”.

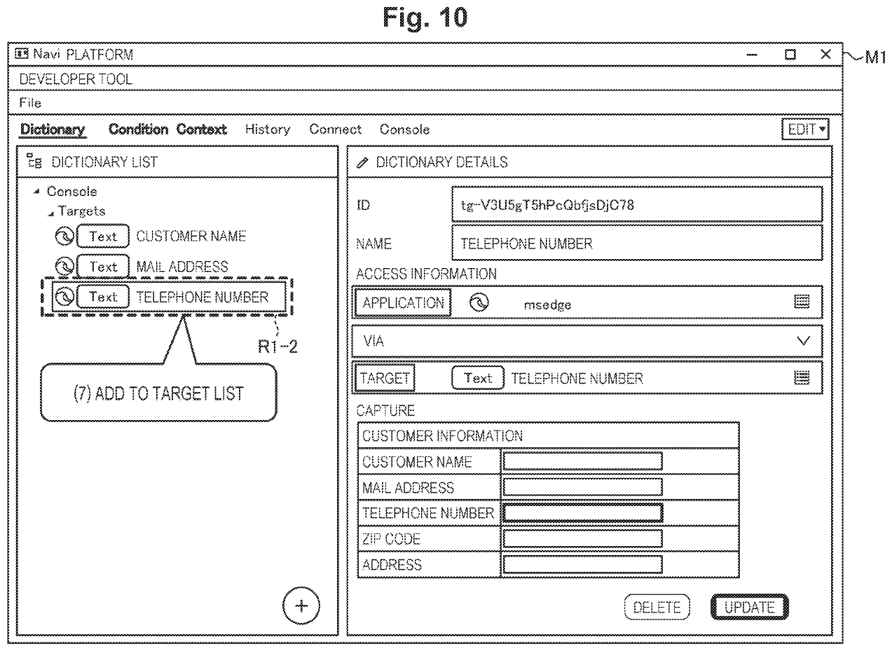

When a registration button B4 of a region R4 is selected by the user ((6) in FIG. 9), the target registration unit 151 adds the telephone number of the target C1, the alias “telephone number”, and the position information of the target C1 as one set to the target list ((7) of FIG. 10, region R1-2).

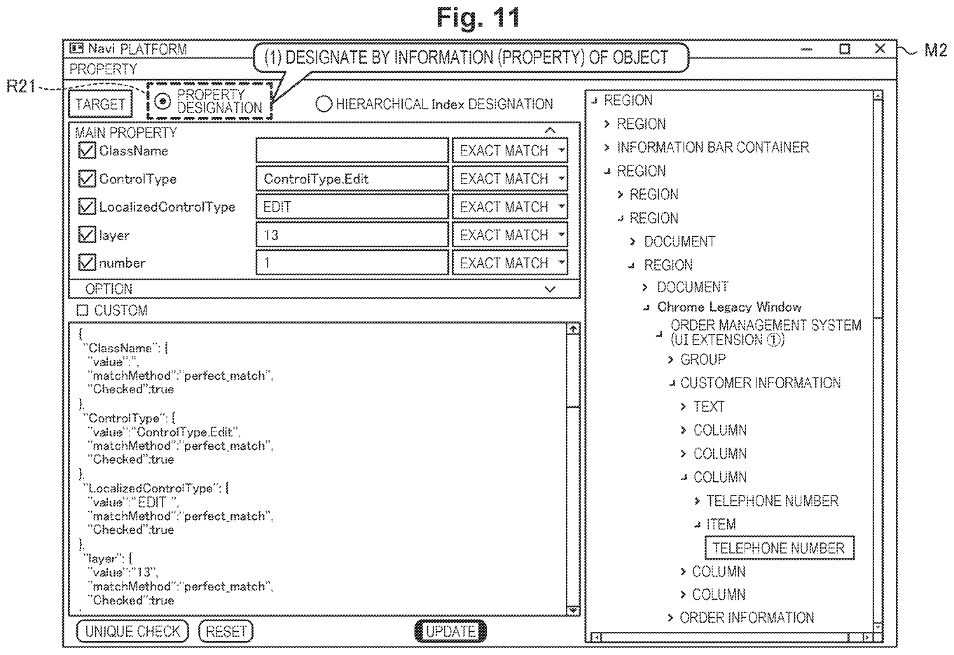

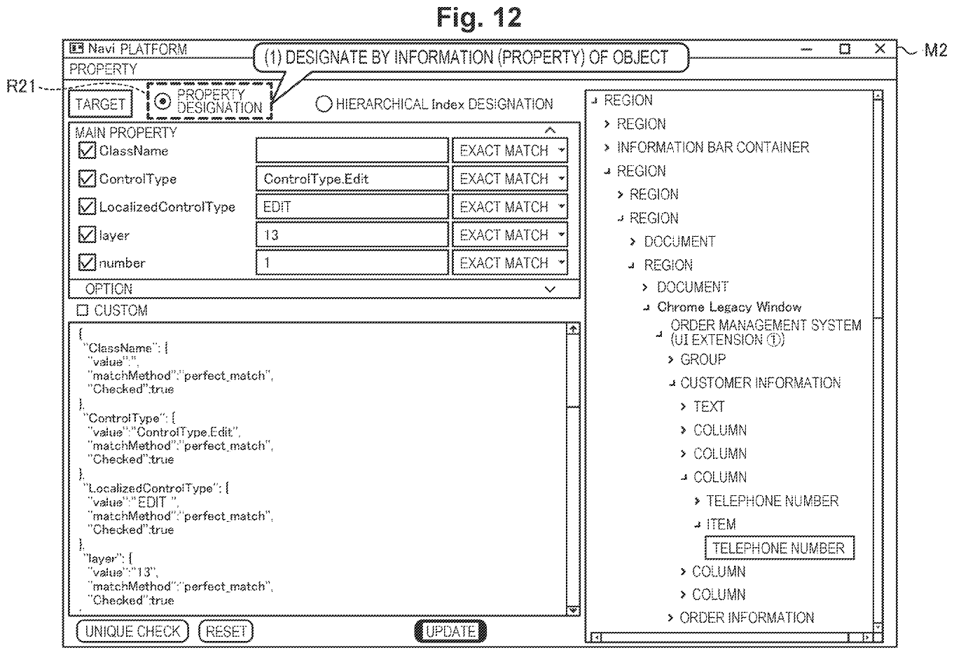

Here, FIG. 11 illustrates a menu M2 for property setting of an automatic operation target. As illustrated in a region R21 of the menu M2, the position information of the target C1 is designated by the information (property) of the object ((1) in FIG. 11). Further, as illustrated in a region R22 of the menu M2, the position information of the target C1 is designated by an index in each hierarchy of the automatic operation target ((2) in FIG. 12).

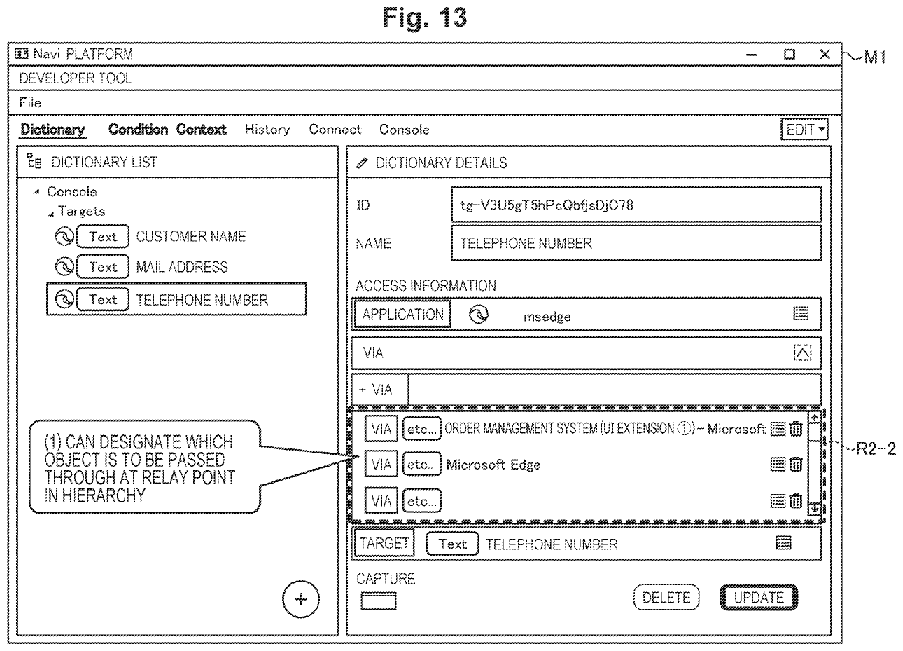

Furthermore, as illustrated in FIG. 13, the user can also designate which object is to be passed through at a relay point in the hierarchy in a via-setting region R2-2 of the position information of the menu M1 ((1) in FIG. 13). The specification of the object can be sped up by designating the relay point. As described above, by combining the properties and indexes of the objects and flexibly setting the relay point as the target position information, the position information can be flexibly set and specified even in a case where the display position of the target object is not uniquely fixed.

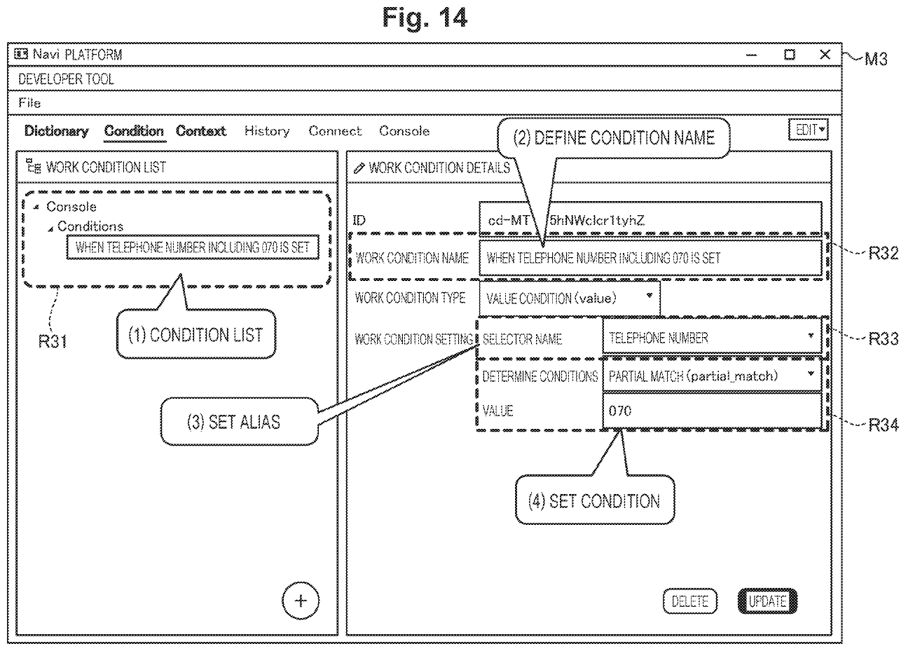

Then, as illustrated in FIG. 14, conditions can be registered on the Condition screen of the menu M1, As illustrated in FIG. 14, in the Condition screen of the menu M1, a condition list is displayed in a left region R31 ((1) in FIG. 14). In the Condition screen, a condition name field in which a condition name can be defined is displayed in a right region R32 ((2) in FIG. 14).

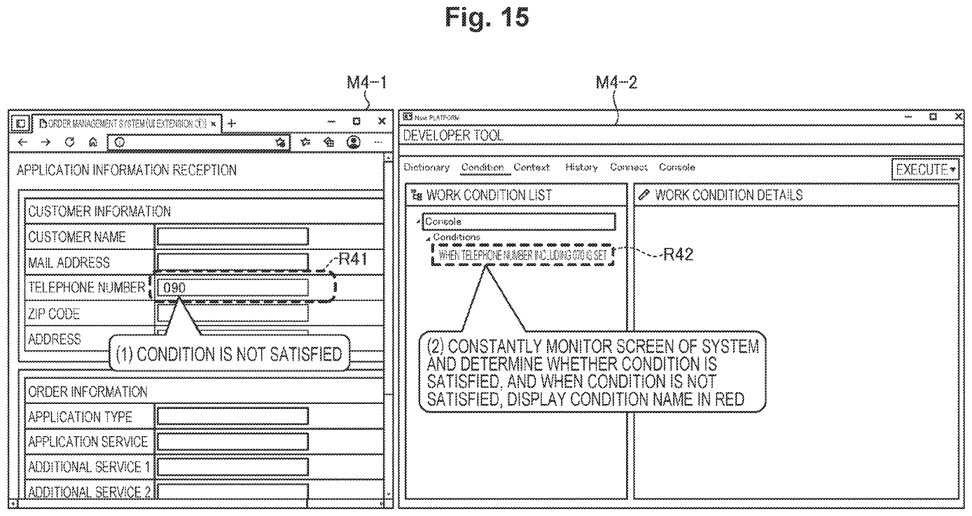

Then, in the Condition screen, a setting field in which the alias can be set is displayed in a right region R33 ((3) in FIG. 14). In the Condition screen, a setting field in which conditions can be set is displayed in a right region R34 ((4) in FIG. 14). In the example of FIG. 14, “when a telephone number including 070 is set” is set as a condition. Note that a registration update button is displayed on the Condition screen. When the user sets each field and selects the update button, the target registration unit 151 sets the condition of the target C1 registered on the Dictionary screen of the menu M1 according to the setting contents on the Condition screen.

[Monitoring of Automatic Operation Target] Next, an operation of the target monitoring unit 153 will be described. For example, as illustrated in FIG. 15, a case where “090” is input in the telephone number field (region R41) of an application information reception menu M4-1 will be described as an example.

The target monitoring unit 153 constantly monitors the screen of the system and determines whether the condition is satisfied ((2) in FIG. 15). In this case, the condition set in FIG. 14 “when a telephone number including 070 is set” is not satisfied ((1) in FIG. 15). When the condition is not satisfied, the target monitoring unit 153 displays the condition name in red, for example, on a Condition screen of the menu M4-2 (region R42 in FIG. 15).

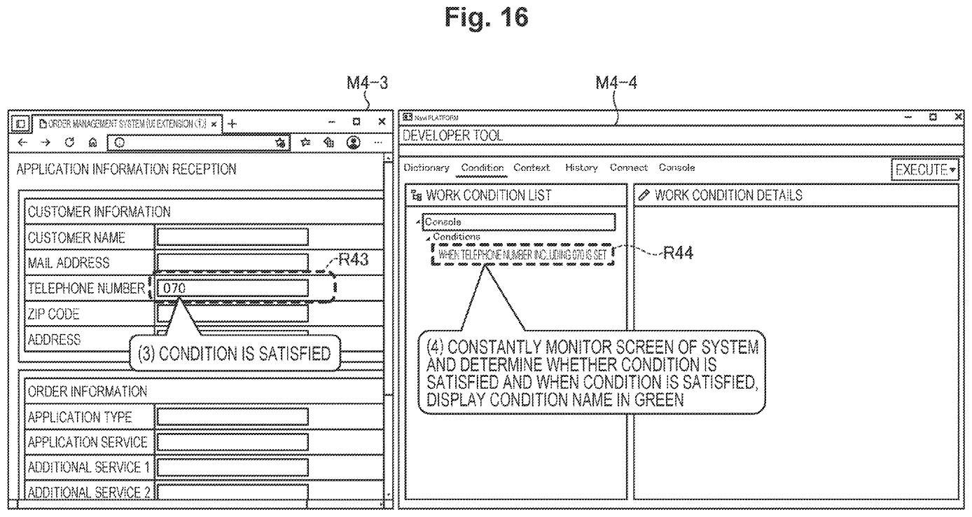

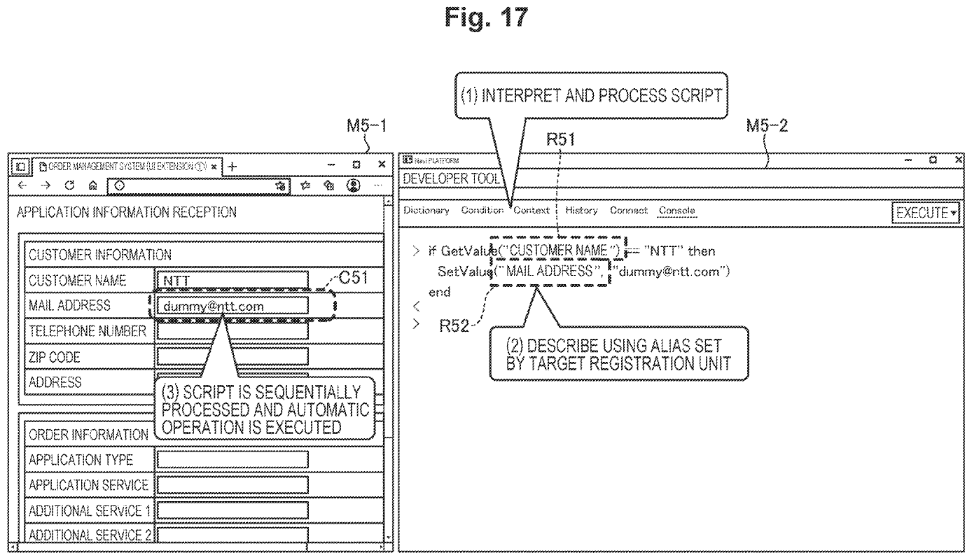

On the other hand, as illustrated in FIG. 16, a case where “070” is input in the telephone number field (region R43) of an application information reception menu M4-3 will be described as an example. The target monitoring unit 153 constantly monitors the screen of the system and determines whether the condition is satisfied ((4) in FIG. 16). In this case, the condition “when a telephone number including 070 is set” set in FIG. 14 is satisfied ((3) in FIG. 16). Therefore, when the condition is satisfied, the target monitoring unit 153 displays the condition name in green, for example, on the Condition screen of a menu M4-4 (region R44 in FIG. 16).

[Execution] Next, an operation of the execution unit 154 will be described. For example, as illustrated in a console screen M5-2 in FIG. 17, the execution unit 154 interprets and processes the corresponding script ((1) in FIG. 17). FIG. 17 illustrates a Lua script language. The script is described using the alias set by the target registration unit 151 ((2) of FIG. 17, regions R51 and R52).

The execution unit 154 replaces the alias with the object information of the automatic operation target. Then, the script is sequentially processed by the execution unit 154, and the automatic operation of the system screen is executed ((3) in FIG. 17). As a result, “dummy@ntt.com” is automatically input to a mail address field C51 of an application information reception menu M5-1.

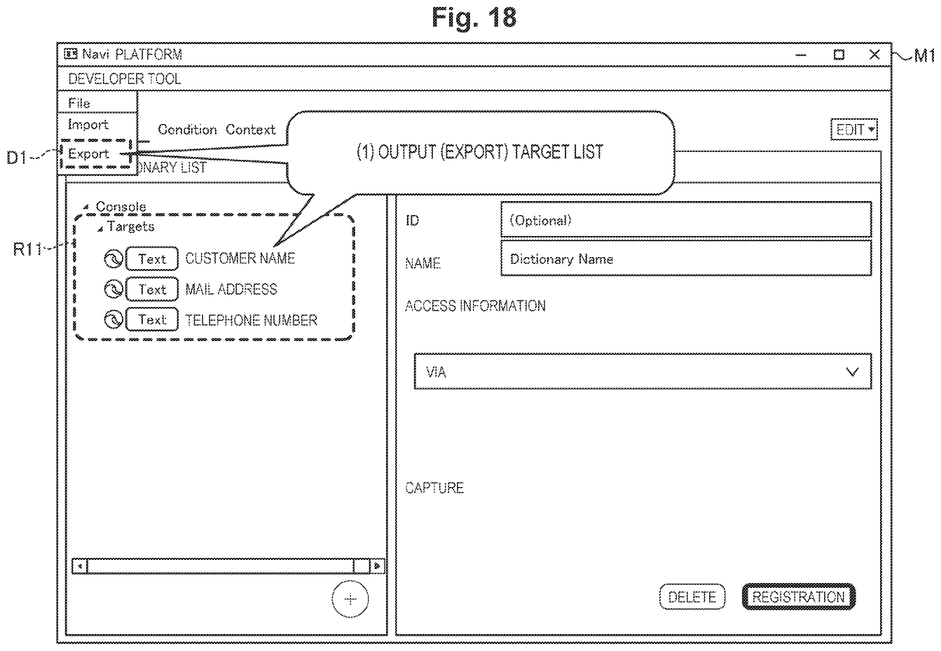

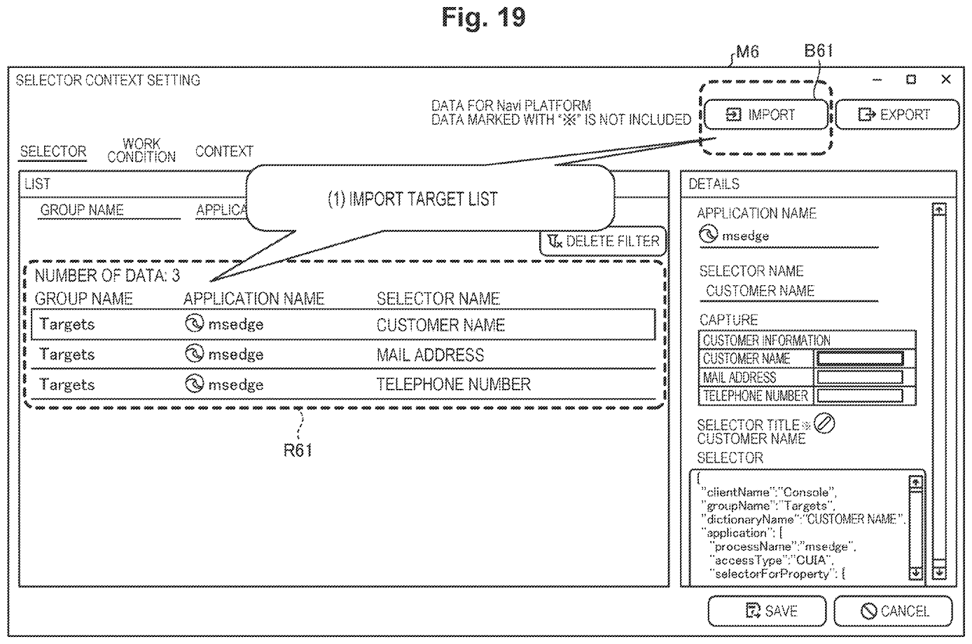

As illustrated in FIG. 18, the user can output (export) the target list in a region R11 by pulling down a File and selecting an export field D1 in the menu M1.

[Description of Control] Next, an implementation example of software in which the control description unit 152 is implemented will be described. In the menu M6 of FIG. 19, the import button B61 is selected to import the target list ((1) of FIG. 19 and region R61).

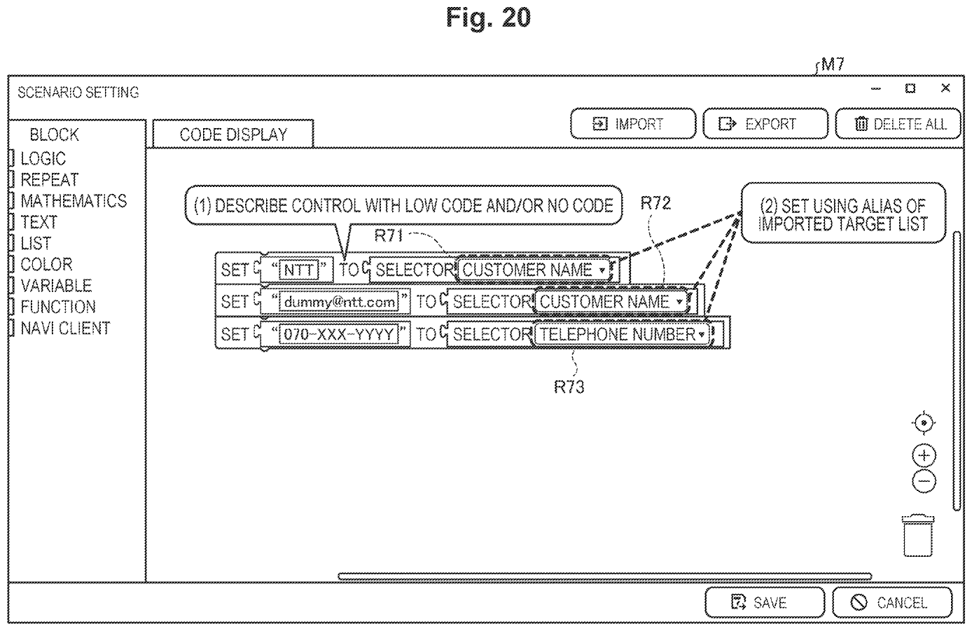

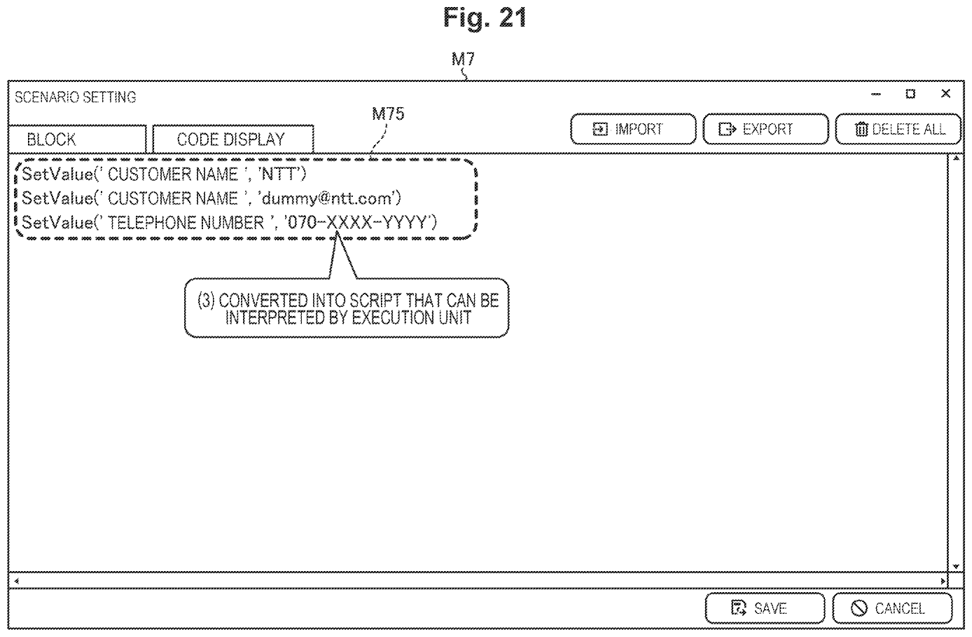

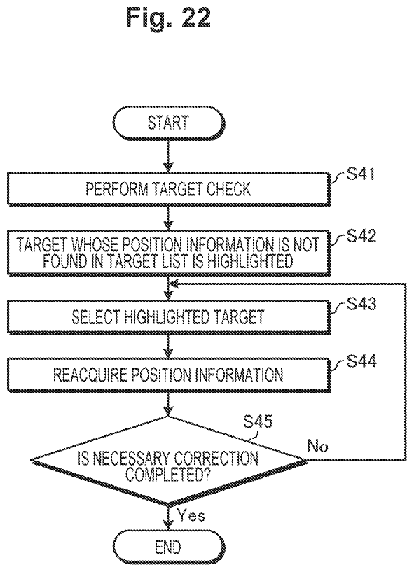

As illustrated in a menu M7, the control description unit 152 describes control of automatic operation with a low code and/or no code for a target in the target list ((1) in FIG. 20). Note that, in FIG. 20, block-type visual programming is illustrated. The control description unit 152 sets description contents using the alias of the imported target list ((2) of FIG. 20 and regions R71 to R73). Then, the script is converted into a script that can be interpreted by the execution unit 154 by the control description unit 152 ((3) of FIG. 21 and frame M75 of FIG. 21).

[Update of Target List when System Screen is Changed] Next, a procedure of updating the target list 141 when the system screen changes will be described. FIG. 22 is a flowchart illustrating a procedure of update processing of the target list when the system screen is changed.

As illustrated in FIG. 22, the target registration unit 151 performs a target check on a system screen to be checked (step S41), and in a case where there is a target whose position information is not found in the target list 141, the target is highlighted (step S42).

When the highlighted target is selected (step S43), the target registration unit 151 reacquires the position information of the highlighted target in the system screen (step S44), and updates the position information of the target in the target list 141 to the reacquired position information.

The target registration unit 151 determines whether necessary correction has been completed for the system screen to be checked (step S45). If necessary correction has not been completed for the system screen to be checked (step S45: No), the target registration unit 151 returns to step S43. If necessary correction has been completed for the system screen to be checked (step S45: Yes), update processing of the target list for this system screen ends.

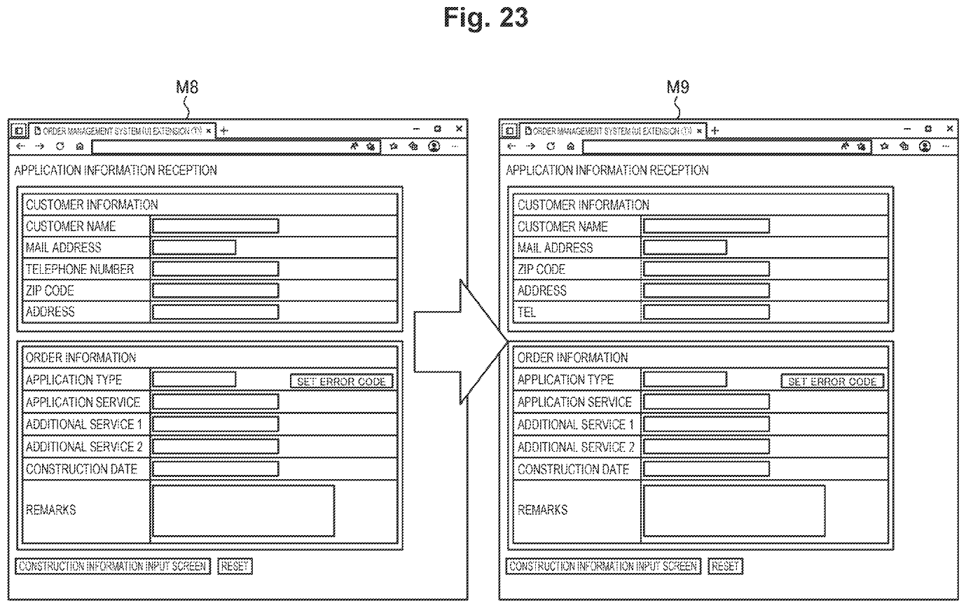

FIGS. 23 to 28 are diagrams illustrating an example of a menu screen displayed on the automatic operation target device. A case where the system screen is changed from a menu M8 to a menu M9 in FIG. 23 will be described as an example. The menu M9 is different from the menu M8 in the position information of the telephone number.

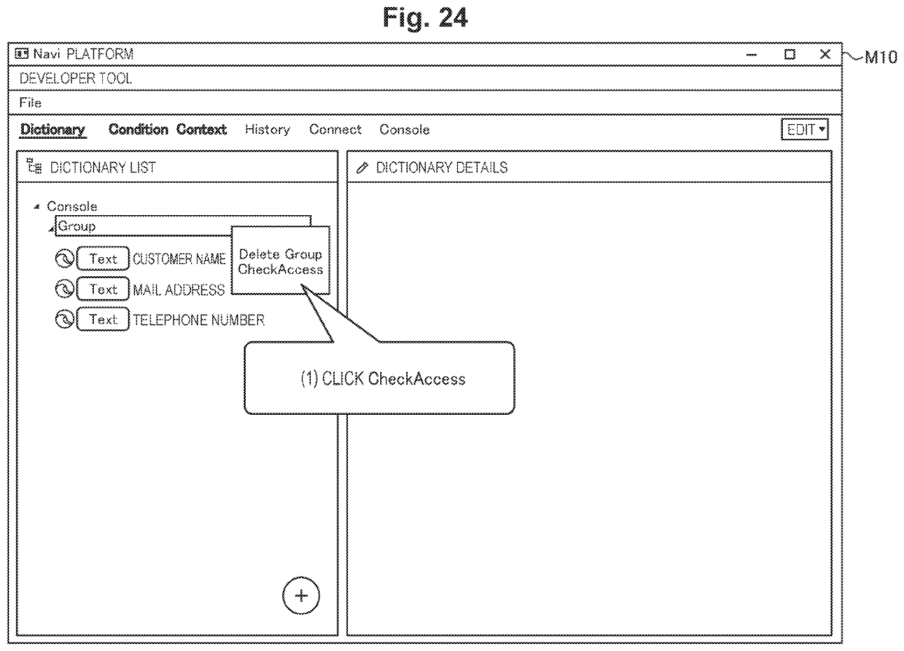

In this case, the user clicks CheckAccess from a pull-down menu of Group on the Dictionary screen of a menu M10 in FIG. 24 ((1) in FIG. 24).

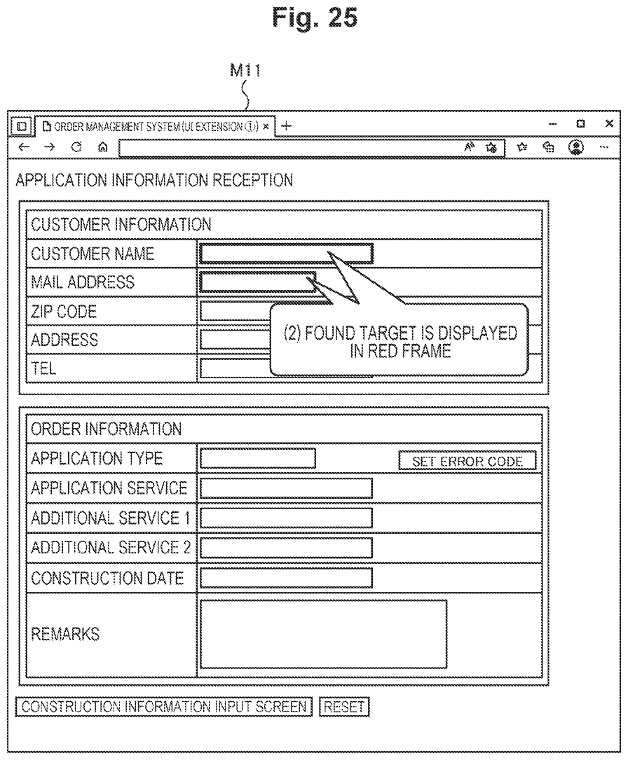

As a result, as illustrated in FIG. 25, in an information reception menu M11, a frame (for example, a red frame) is displayed in the target whose position information has been found to be changed ((2) in FIG. 25).

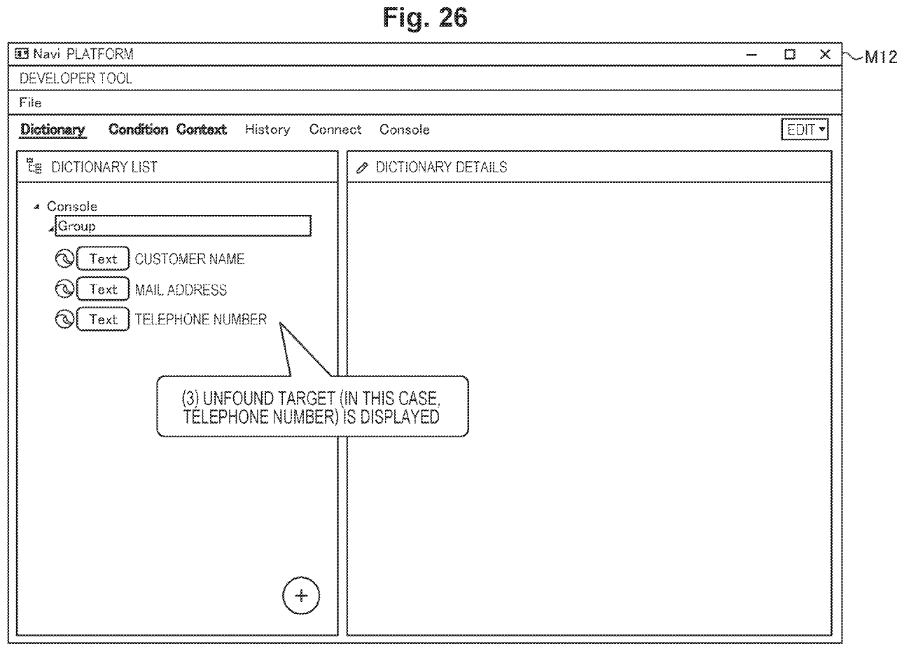

Then, as illustrated in a menu M12 in FIG. 26, in a case where the position information of the target displayed on the system screen is not found in the target list, the unfound target (in this case, the telephone number) is displayed in red, for example ((3) in FIG. 26).

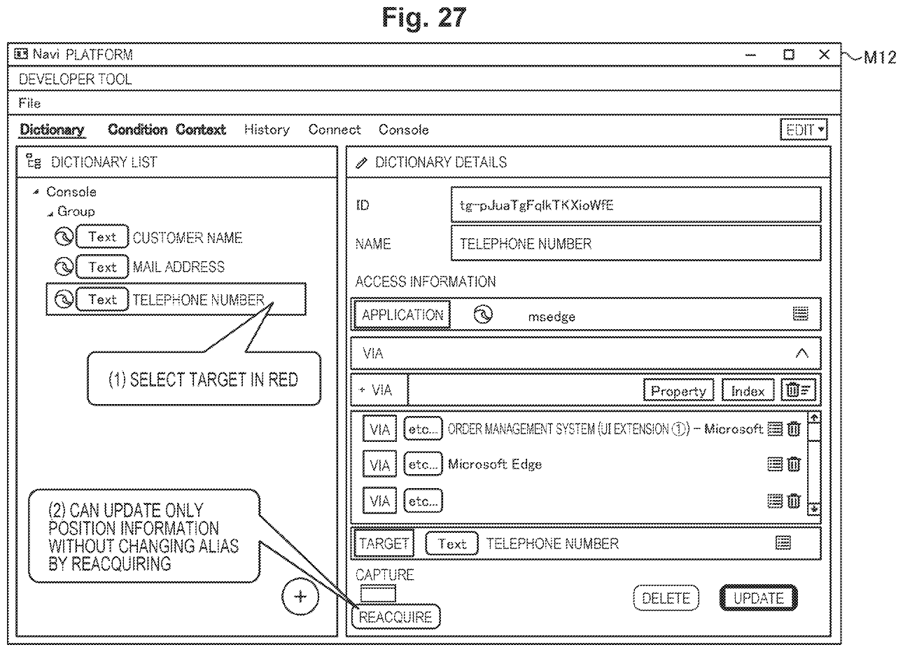

As illustrated in FIG. 27, the user selects a target in red ((1) in FIG. 27). In this case, the target registration unit 151 updates only the position information of the target in red (in this case, the telephone number) without changing the alias by reacquiring the position information in the telephone number field on the system screen after the change ((2) in FIG. 27).

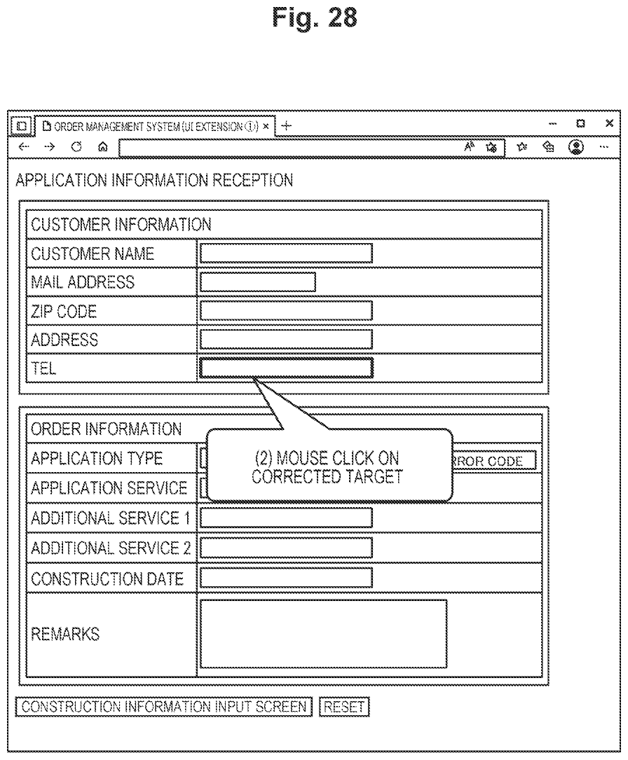

As illustrated in FIG. 28, when a target whose position information has been corrected is clicked with a mouse on the system screen after the change ((2) in FIG. 28), processing related to automatic operation is executed. In the target list, the target registration unit 151 does not correct the alias having the same targets (in this case, telephone numbers) but updates only the position information.

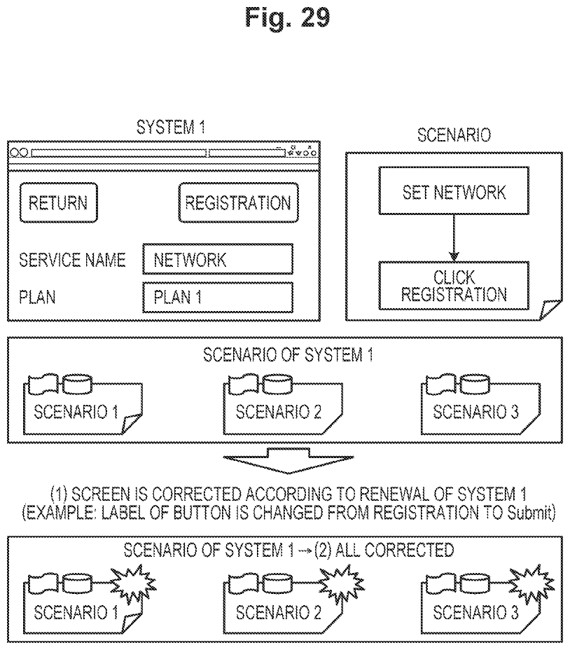

As described above, in a case where the system screen is changed, when there is a system screen whose position information is not found in the target list regarding the system screen after the change, the target registration unit 151 reacquires the position information of the target and updates the position information of the target in the target list to the reacquired position information.

[Effects of Embodiment] FIG. 29 is a diagram for explaining a conventional RPA. In the existing RPA, information on an automatic operation target and control is integrally described in a form of a scenario or a rule. For this reason, in the conventional RPA, when the system screen to be the target of the automatic operation is corrected by the renewal of the system 1 (for example, in a case where the label of the button is changed from “register” to “submit”,) ((1) in FIG. 29), it is necessary to correct all scenarios and rules related to the corresponding system screen ((2) in FIG. 29).

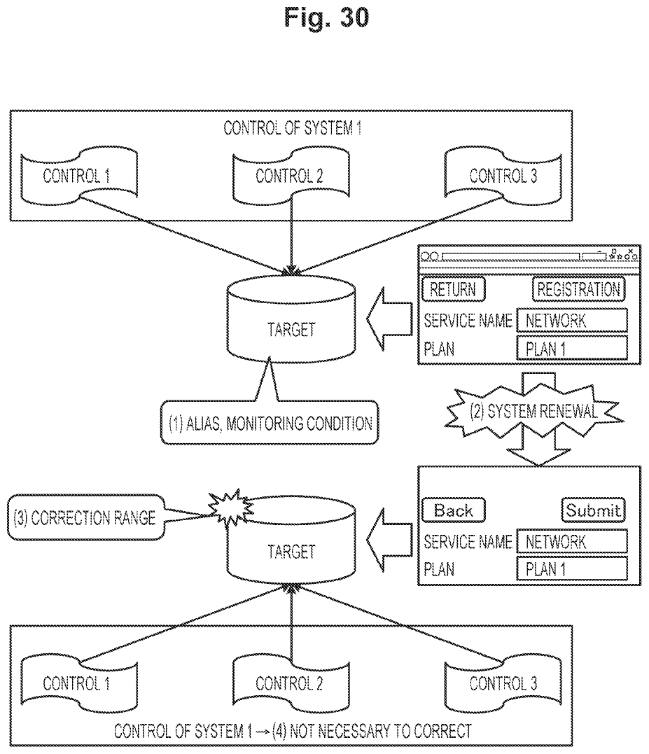

FIG. 30 is a diagram illustrating the processing device 10 according to the embodiment. As illustrated in FIG. 29, the processing device 10 manages the automatic operation by separating the control from the automatic operation target. The processing device 10 aggregates information that is likely to be affected by the environment, such as a system screen, into target information (alias, monitoring condition) and generates the target information for each system ((1) in FIG. 30).

Therefore, in the processing device 10, even in a case where the system screen to be the target of the automatic operation is corrected by the system renewal ((2) in FIG. 30), a correction range is only the target information ((3) in FIG. 30). In the processing device 10, since it is not necessary to correct the control of the system 1, the control may be described using the corrected target information.

Therefore, in the processing device 10, even in a case where an environment change such as a change of the system screen occurs, only the target information is corrected, and thus, it is not necessary to correct the control described using the target information ((4) in FIG. 30). In other words, according to the processing device 10, since the correction range is only the target information, it is possible to reduce the influence on the correction of the scenario and the rule due to the environment change.

Furthermore, in the processing device 10, since the position information of the automatic operation target registered by the target registration unit 151 is represented hierarchically by the object information or the index, the position information of the automatic operation target can be appropriately registered. In addition, in the processing device 10, since a unique alias is defined for each position information, it is possible to appropriately manage the position information of the automatic operation target.

Furthermore, in the processing device 10, the control description unit 152 sets a condition including an existence condition, a value condition, and/or a timing condition using the alias, and defines a unique condition name for each condition, so that the condition of the automatic operation can be appropriately managed.

In the processing device 10, the control description unit 152 describes control using any of the execution methods of immediate execution and execution in a case where an execution condition set by combining condition names is satisfied. Therefore, as compared with the conventional method of integrally creating all the scenarios and rules, the processing device 10 does not need to consider all the scenarios and rules, and can easily describe a description of a procedure such as “wait until a state in which the scenario or rule may be executed due to monitoring the screen” in which the automatic operation is performed after waiting until the system screen transitions to the next screen.

[System Configuration of Embodiment] Each component of the processing device 10 is functionally conceptual, and does not necessarily have to be physically configured as shown in the drawings. That is, specific forms of distribution and integration of the functions of the processing device 10 are not limited to the illustrated forms, and all or a part thereof can be functionally or physically distributed or integrated in any unit according to various loads, usage conditions, and the like.

Moreover, all or any part of processing performed in the processing device 10 may be implemented by a CPU, a graphics processing unit (GPU), or a program analyzed and executed by the CPU or the GPU, Moreover, each processing performed in the processing device 10 may be implemented as hardware by wired logic.

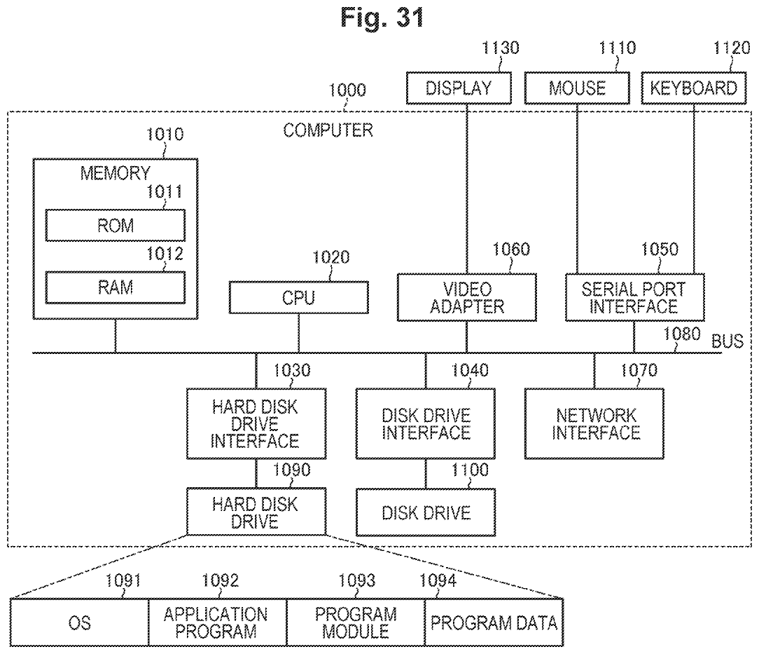

Moreover, among the pieces of processing described in the embodiment, all or part of the processing described as being automatically performed can be manually performed. Alternatively, all or a part of the processing described as being manually performed can be automatically performed by a known method. In addition, the above-described and illustrated processing procedures, control procedures, specific names, and information including various data and parameters can be appropriately changed unless otherwise specified.

[Program] FIG. 31 is a diagram illustrating an example of a computer on which a processing device 10 is implemented by executing a program. A computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected via a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120, The video adapter 1060 is connected to, for example, a display 1130.

The hard disk drive 1090 stores, for example, an operating system (OS) 1091, an application program 1092, a program module 1093, and program data 1094. That is, a program that defines each processing of the processing device 10 is implemented as the program module 1093 in which a code executable by the computer 1000 is described. The program module 1093 is stored in, for example, the hard disk drive 1090. For example, the program module 1093 for executing processing similar to the functional configurations in the processing device 10 is stored in the hard disk drive 1090. Note that the hard disk drive 1090 may be replaced with a solid state drive (SSD).

Furthermore, setting data used in the processing of the above-described embodiment is stored as the program data 1094, for example, in the memory 1010 or the hard disk drive 1090. The CPU 1020 then reads the program module 1093 and the program data 1094 stored in the memory 1010 or the hard disk drive 1090 into the RAM 1012 as necessary and executes the program module 1093 and the program data 1094.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). The program module 1093 and the program data 1094 may be read by the CPU 1020 from the another computer via the network interface 1070.

Although the embodiment to which the invention made by the present inventors is applied has been described above, the present invention is not limited by the description and drawings constituting a part of the disclosure of the present invention according to the present embodiment. That is, other embodiments, examples, operation techniques, and the like made by those skilled in the art on the basis of the present embodiments are all included in the scope of the present invention.

Reference Signs List

| | |
|---|---|
| 10 | Processing device |
| 11 | Input unit |
| 12 | Output unit |
| 13 | Communication unit |
| 14 | Storage unit |
| 15 | Control unit |
| 141 | Target list |
| 142 | Condition list |
| 151 | Target registration unit |
| 152 | Control description unit |
| 153 | Target monitoring unit |
| 154 | Execution unit |

1. A processing device comprising:
processing circuitry configured to:
designate an automatic operation target displayed on a system screen, and register and manage position information and an alias of the designated automatic operation target as target information;
describe control of an automatic operation by a low code and/or no code using the target information registered, describe an execution condition when the execution condition exists, and convert the execution condition into a predetermined script;
monitor information of an application on a desktop, determine whether or not an execution condition set is satisfied, and output a corresponding script when it is determined that the execution condition is satisfied; and
interpret the script converted, replace the alias with object information of an automatic operation target, sequentially process the script, and perform an automatic operation of the system screen.

2. The processing device according to claim 1, wherein
the position information of the automatic operation target registered is represented hierarchically by object information or an index, and
the processing circuitry is further configured to define a unique alias for each piece of position information.

3. The processing device according to claim 1, wherein the processing circuitry is further configured to set a condition including an existence condition, a value condition, and/or a timing condition using an alias, and define a unique condition name for each condition.

4. The processing device according to claim 1, wherein the processing circuitry is further configured to describe control using any of an execution method including immediate execution and execution in a case where an execution condition set by combining condition names is satisfied.

5. The processing device according to claim 1, wherein, in a case where the system screen is changed, when a first target for which position information is not found exists in the target information with respect to the system screen after the change, the processing circuitry is further configured to reacquire position information of the first target, and update the position information of the first target in the target information to the reacquired position information.

6. A processing method executed by a processing device, comprising:
designating an automatic operation target displayed on a system screen, and registering and managing position information and an alias of the designated automatic operation target as target information;
describing control of an automatic operation by a low code and/or no code using the target information registered, describing an execution condition when the execution condition exists, and converting the execution condition into a predetermined script;
monitoring information of an application on a desktop, determining whether or not an execution condition set is satisfied, and outputting a corresponding script when it is determined that the execution condition is satisfied; and
interpreting the script converted, replacing the alias with object information of an automatic operation target, sequentially processing the script, and performing an automatic operation of the system screen.

7. A non-transitory computer-readable recording medium storing therein a processing program that causes a computer to execute a process comprising:
designating an automatic operation target displayed on a system screen, and registering and managing position information and an alias of the designated automatic operation target as target information;
describing control of an automatic operation by a low code and/or no code using the target information registered, describing an execution condition when the execution condition exists, and converting the execution condition into a predetermined script;
monitoring information of an application on a desktop, determining whether or not an execution condition set is satisfied, and outputting a corresponding script when it is determined that the execution condition is satisfied; and
interpreting the script converted, replacing the alias with object information of an automatic operation target, sequentially processing the script, and performing an automatic operation of the system screen.
